(19) United States
(12) Patent Application Publication
(10) Pub. No.: US 2023/0361592 A1
(43) Pub. Date: Nov. 9, 2023

(54) CHARGER AND CHARGING SYSTEM

(71) Applicant: ANNVOLT TECHNOLOGY CO., LTD., New Taipei City (TW)

(72) Inventors: Dong Sheng Li, New Taipei City (TW); Tung-Sheng Lin, New Taipei City (TW)

(73) Assignee: ANNVOLT TECHNOLOGY CO., LTD., New Taipei City (TW)

(21) Appl. No.: 18/221,888

(22) Filed: Jul. 14, 2023

Related U.S. Application Data
(63) Continuation-in-part of application No. 17/535,822, filed on Nov. 26, 2021.
(60) Provisional application No. 63/118,653, filed on Nov. 26, 2020.

(51) Int. Cl. H02J 7/00

(52) U.S. Cl. CPC H02J 7/00712; H02J 7/00034; H02J 7/0036

(57) ABSTRACT

An improved charger and charging system for an electronic device is provided. The charger includes a power delivery controller configured to determine which pins of a USB Type-C connector are used for charging. The power delivery controller is capable of designating pins other than the VBUS pin for charging, thereby distributing the current for charging an electronic device more efficiently.

### FIELD OF THE DISCLOSURE

The present invention relates generally to the field of electronic device charging systems. More specifically, the invention relates to a charger(power adapter) and a charging system for an electronic device that utilizes a USB Type-C connector and an enhanced charging mode.

### BACKGROUND OF THE INVENTION

In the field of electronic devices, charging efficiency and safety are of paramount importance. Traditional charging systems often use a standard Power Delivery (PD) protocol with a USB Type-C connector. In these systems, the VBUS pin of type C connector is typically used for charging. However, this approach has several limitations.

Firstly, the use of a single VBUS pin for charging can lead to an uneven distribution of current, which can potentially overload the pin and reduce the lifespan of the connector. This can also limit the charging speed, as the current capacity of a single pin is limited.

Secondly, traditional charging systems often lack flexibility in terms of charging modes. They typically operate in a single fixed output voltage mode, regardless of the specific requirements or capabilities of the electronic device being charged. This can lead to inefficiencies in power usage and can potentially damage the electronic device if the charging mode is not suitable for the device's requirements. However, certain electronic devices, such as high-capacity batteries or motors, require charging in constant current mode. In such cases, the typical fixed output voltage can't meet the charging requirements of the electronic devices.

Furthermore, traditional charging systems often do not have mechanisms in place to minimize power consumption when the charger is disconnected from the electronic device or when the charger falls out of its operating mode. This can lead to unnecessary power wastage and can reduce the overall efficiency of the charging system.

Therefore, there is a need for an improved charger and charging system that addresses these limitations of the prior art.

### SUMMARY OF THE INVENTION

The present invention provides an improved charger and charging system for an electronic device that addresses the limitations of the prior art. The charger includes a power delivery controller configured to determine which pins of a USB Type-C connector are used for charging. The power delivery controller is capable of designating pins other than the VBUS pin for charging, thereby distributing the current for charging an electronic device more efficiently.

The charger includes a first routed line connecting a power line of the charger to the designated pins. The first routed line may include a switch capable of opening to disconnect the first routed line. The charger operates in an enhanced charging mode when the electronic device supports this mode and includes a second routed line connecting the designated pins to a power line of the electronic device.

The enhanced charging mode is deactivated when the electronic device does not support this mode. A handshake between the charger and the electronic device determines whether the electronic device supports the enhanced charging mode. The switch on the first routed line is closed when the electronic device supports the enhanced charging mode, allowing power to flow through the first and second routed lines and charging to begin.

The charger may also include resistors installed on the first routed line and the power line of the charger to achieve current equalization. The charger supports a multi-stage charging mode, including a Trickle Charge stage using the lowest constant current, a Pre-charge stage with a higher constant current, a CC Fast Charge stage using an even higher constant current, and a Constant Voltage Charge stage where the voltage is kept constant, but the current decrease gradually due to almost full charge.

When the charger is disconnected from the electronic device or falls out of its operating mode, the output voltage of power converter is reduced to the lowest permissible working value, allowing the power delivery controller to enter a sleep mode, minimizing power consumption.

The foregoing, as well as additional objects, features and advantages of the invention will be more readily apparent from the following detailed description, which proceeds with reference to the accompanying drawings.

### BRIEF DESCRIPTION OF THE DRAWINGS

The objects, spirits, and advantages of the preferred embodiments of the present disclosure will be readily understood by the accompanying drawings and detailed descriptions, wherein:

FIG. 1 shows pin layout of the USB Type-C connector.

FIG. 2 shows a charging system of a first embodiment of the present invention.

FIG. 3 shows a charging system of a first embodiment of the present invention.

FIG. 4 illustrates the stages of the multi-stage charging mode.

FIG. 5 provides a visual representation of how the efficiency of the charger varies with the output power.

FIG. 6A shows a charger of a third embodiment of the present invention.

FIG. 6B shows a charger of a fourth embodiment of the present invention.

FIG. 7 illustrates the stages of another multi-stage charging mode.

### DESCRIPTION OF THE PREFERRED EMBODIMENTS

The USB Type-C connector, also known as USB-C, is a type of USB (Universal Serial Bus) connector that has gained popularity in recent years due to its reversible plug orientation and cable direction. It is designed to be small enough to fit into a smartphone's charging port but robust enough to connect to larger devices such as laptops and desktop computers.

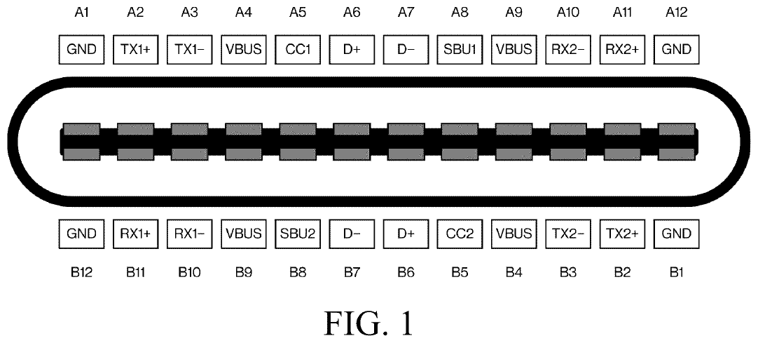

Please refer to FIG. 1. FIG. 1 shows pin layout of the USB Type-C connector. The USB Type-C connector has a 24-pin design, with 12 pins on each side, mirrored to ensure the plug's reversibility. In FIG. 1, the designations and names of each pin are indicated. The pins are designated as follows:

Type-C Receptacle A Pin Layout:

A1: GND (Ground return)

A2: SSTXp1 (SuperSpeed differential pair #1, TX1+, positive)

A3: SSTXn1 (SuperSpeed differential pair #1, TX1−, negative)

A4: VBUS (Bus power)

A5: CC1 (Configuration channel)

A6: Dp1 (USB 2.0 differential pair, position 1, D+, positive)

A7: Dn1 (USB 2.0 differential pair, position 1, D−, negative)

A8: SBU1 (Sideband use)

A9: VBUS (Bus power)

A10: SSRXn2 (SuperSpeed differential pair #4, RX2−, negative)

A11: SSRXp2 (SuperSpeed differential pair #4, RX2+, positive)

A12: GND (Ground return)

Type-C Receptacle B Pin Layout:

B1: GND (Ground return)

B2: SSTXp2 (SuperSpeed differential pair #3, TX2, positive)

B3: SSTXn2 (SuperSpeed differential pair #3, TX2, negative)

B4: VBUS (Bus power)

B5: CC2 (Configuration channel)

B6: Dp2 (USB 2.0 differential pair, position 2, D, positive)

B7: Dn2 (USB 2.0 differential pair, position 2, D, negative)

B8: SBU2 (Sideband use)

B9: VBUS (Bus power)

B10: SSRXn1 (SuperSpeed differential pair #2, RX1, negative)

B11: SSRXp1 (SuperSpeed differential pair #2, RX1, positive)

B12: GND (Ground return)

Each pin serves a specific function in the USB Type-C connector. For instance, the VBUS pins (A4 and A9, B4 and B9) carry the power for the bus, the GND pins (A1 and A12, B1 and B12) provide the ground return, and the SSTX and SSRX pins are used for SuperSpeed data transmission. The CC pins (A5 and B5) are used for cable orientation detection and functionality configuration, while the SBU pins (A8 and B8) are reserved for future use.

In the context of this patent application, the power delivery controller in the charger can designate pins other than the VBUS pin for charging, such as the TX1 and TX2 pins. These designated pins can include the TX1 and TX2 pins, both positive and negative, as well as the GND pin for return current, such as RX1 and RX2, both positive and negative. This allows the charger to operate in an enhanced charging mode and distribute current for charging an electronic device through the designated pins.

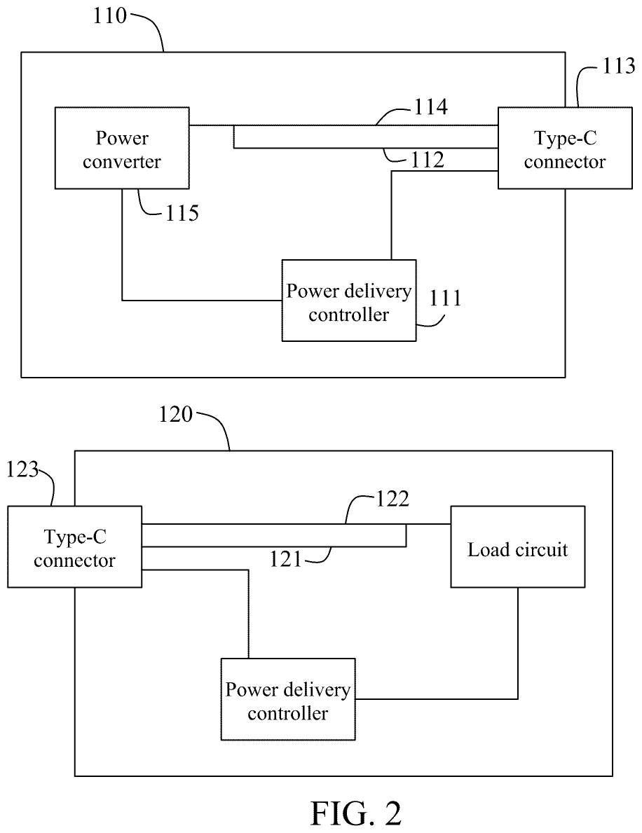

Referring to FIG. 1 and FIG. 2 which shows a charging system of a first embodiment of the present invention, the charging system 100 for an electronic device includes a charger 110 and an electronic device 120. The charger 110 comprises several components, including a power delivery controller 111, a first routed line 112, a USB Type-C connector 113, and a power converter 115. The electronic device 120 includes a second routed line 121 that connects to the designated pins on the USB Type-C connector 123 which connects to the USB Type-C connector 113 of the charger 110 by a USB Type-C cable (not shown). In addition, the second routed line 121 connects the designated pins of the USB Type-C connector 123 to a power line 122 of the electronic device 120.

The power delivery controller 111 is a key component of the charger 110. It is configured to determine which pins of the USB Type-C connector 113 are used for charging. Traditionally, the VBUS pin of the USB Type-C connector 113 is used for charging. However, in the present invention, the power delivery controller 111 has the capability to designate pins other than the VBUS pin for charging. This feature allows for the distribution of current and arrange more pins for charging the electronic device 120, thereby operating in an enhanced charging mode. The designated pins can include, but are not limited to, the TX1 pin and TX2 pin.

The first routed line 112 connects a power line 114 of the charger 110 to the designated pins on the USB Type-C connector 113. The power line 114 serves as the pathway for the current to flow from the power converter 115 to the USB Type-C connector 113. The connection between the first routed line 112 and the designated pins (TX1+/− pin and TX2+/− pin) is established through a series of electrical contacts within the USB Type-C connector 113. These contacts ensure a secure and efficient transfer of electrical current from the first routed line 112 to the designated pins.

In the embodiment, the power converter 115 is a DC-DC converter, which is a component of the charger 110 and responsible for converting the DC output from the AC-DC converter (not shown) into a lower or higher voltage DC power suitable for charging the electronic device 120. The power converter 115 can be designed to operate efficiently over a wide range of input voltages, providing flexibility in the charging process. In other words, the power converter 115 can provide different output voltages depending on the situation, such as 3.3V, 5V, 9V, 12V, 15V, 19V, 20V, 24V, 28V, 32V, 36V, 42V, 48V, 52V, 56V, and 60V. In some embodiment, the power converter 115 can also be an AC-DC converter, which is directly connected to the mains power supply. It converts the incoming AC power into the required DC output voltage.

Thus, the charging system 100 of the present invention, through the use of the power delivery controller 111 and the first routed line 112, can utilize pins of the USB Type-C connector 113 other than the VBUS pin for charging the electronic device 120. This allows for an enhanced charging mode that can provide improved charging performance.

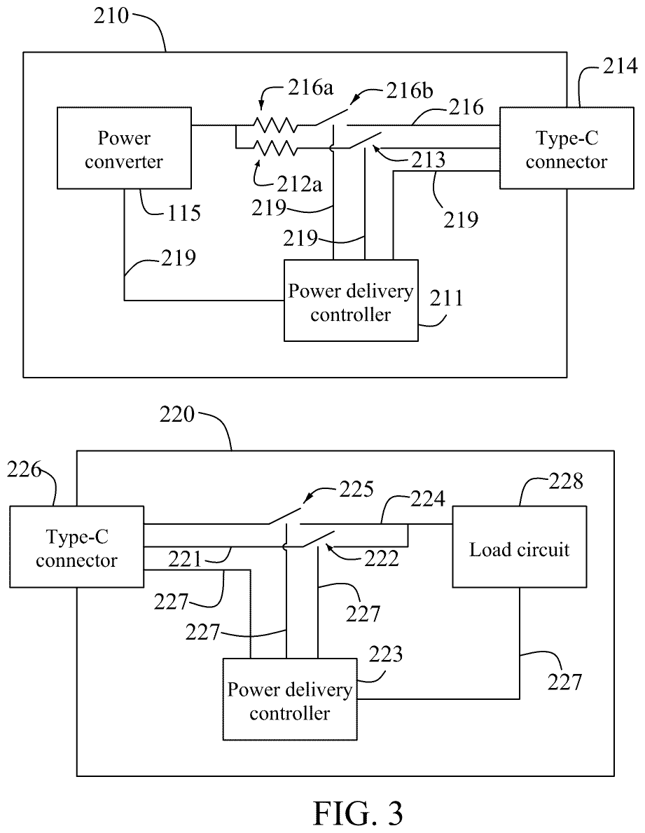

Referring to FIG. 3, the charging system 200 includes a charger 210 and an electronic device 220. The charger 210 comprises a power delivery controller 211, a first routed line 212 with a first switch 213, and a USB Type-C connector 214. The electronic device 220 includes a second routed line 221 with a second switch 222. These switches can be implemented using various types of electronic switches, such as MOSFET, transistors, relays, or other suitable components.

The first switch 213 on the first routed line 212 plays a crucial role in the operation of the charger 210. It is capable of opening to disconnect the first routed line 212, thereby controlling the flow of current from the charger 210 to the electronic device 220. Similarly, the second switch 222 on the second routed line 221 can open to disconnect the second routed line 221, controlling the flow of current within the electronic device 220.

The operation of the first switch 213 and the second switch 222 is coordinated through a handshake mechanism between the power delivery controller 211 of the charger 210 and the power delivery controller 223 of the electronic device 220. This handshake mechanism acknowledges whether the electronic device 220 supports the enhanced charging mode. If the electronic device 220 supports the enhanced charging mode, the first switch 213 on the first routed line 212 and a fifth switch 216b on the power line 216 is closed, allowing power to flow through the first routed line 212 and second routed lines 221 and charging to begin.

On the other hand, if the electronic device 220 does not support the enhanced charging mode, the first switch 213 on the first routed line 212 is opened, disconnecting the first routed line 212. In this case, the charger 210 and the electronic device 220 revert to standard Power Delivery (PD) charging. During standard PD charging, power output from the POWER converter 115 in the charger 210 is directed through the power line 216 to the VBUS pin of the USB Type-C connector 214. This handshake mechanism ensures that the charging system 200 can adapt to the capabilities of the electronic device 220, providing an enhanced charging mode when possible and reverting to standard charging when necessary.

Therefore, the charging system 200 of the present invention, through the use of a switch on the first routed line 212 and a handshake mechanism, can adaptively control the charging process based on the capabilities of the electronic device 220. This allows for an enhanced charging mode that can provide improved charging performance when the electronic device 220 supports it, and a standard charging mode when the electronic device 220 does not.

In the above embodiment, it's important to note that both the charger 210 and the electronic device 220 are equipped with signal lines, specifically signal lines 219 and 227 respectively. These signal lines are connected to the USB Type-C connector 214 and Type-C connector 226, reaching various pins such as CC1/CC2, DAT/CLK, RX/TX(UART), and others. A portion of these signal lines, namely some of the signal lines 219 and 227, are responsible for transmitting instructions from the power delivery controllers 211 and 223 to the switches. Furthermore, within the electronic device 220, the signal lines 227 also serve to convey information to the load circuit 228. The load circuit 228 represents the part of the device that consumes power, such as a computer processor.

It's worth mentioning that the depiction of signal lines 219 and 227 in FIG. 3 is purely illustrative. Those skilled in the art would understand that the actual layout of the signal lines in a real-world application would be considerably more complex than what is shown in the figure. This simplified representation is used to make the diagram clearer and easier to understand.

In the second embodiment, a fifth switch 216b is optionally installed on the power line 216 of the charger 210. The purpose of this design is to prevent consumers from mistakenly connecting the charger 210 to other chargers. Therefore, the fifth switch 216b ensures that it only conducts when the charger 210 is connected to a chargeable device. Furthermore, a sixth switch 225 can also be optionally installed on the power line 224 of the electronic device 220. This design ensures that the sixth switch 225 only conducts when the voltage supplied by the charger 210 matches the voltage required by the electronic device 220.

In addition, the power delivery controller 211 is capable of reassigning the functions of various pins on the USB Type-C connector 214, allowing for enhanced functionality beyond just power delivery. For instance, the D+/D− (Dp/Dn) pins can be reassigned to function as SDA/SCL pins. SDA (Serial Data) and SCL (Serial Clock) are used in I2C communication, a type of serial communication protocol. By reassigning these pins, the charger 210 and the electronic device 220 can communicate using the I2C protocol. This allows for more complex communication and negotiation of power requirements, enhancing the adaptability of the charging system 200.

Similarly, the SBU1/SBU2 pins can be reassigned to function as RX/TX(UART) or DAT/CLK pins. RX and TX are typically used for serial communication (receive and transmit, respectively), while DAT/CLK could refer to data and clock in a serial communication protocol. This reassignment can be used to update the firmware in the power delivery controller 211 of the charger 210, allowing it to support new power delivery profiles or to better optimize power delivery for specific devices. Furthermore, the USB (Universal Serial Bus) signal RX1+/−, RX2+/− pins, which are normally used for receiving data with super speed, can be repurposed as ground connections (GND). This reassignment can enhance the stability of the charging system 200.

In brief, the charging system 200 of the present invention, through the reassignment of pin functions by the power delivery controller 211 and the power delivery controller 223, can provide enhanced functionality beyond just power delivery. This includes more complex communication between the charger 210 and the electronic device 220, the ability to update the firmware of the charger 210 for optimized power delivery, and the enhancement of system stability through the repurposing of data receiving pins as ground connections. These features collectively contribute to a more adaptable, efficient, and robust charging system.

In some embodiments, current equalization (or current-sharing) is a crucial aspect that ensures efficient and safe charging of the electronic device 220. This is achieved through the installation of a resistor 212a on the first routed line 212 and a resistor 216a on the power line 216. The resistors 212a and 216a are strategically placed on the first routed line 212 and the power line 216 respectively. This is important when the power delivery controller 211 designates multiple pins for charging, as it ensures that no single pin is overloaded with current, which could potentially lead to overheating or damage. The resistors 212a and 216a serve to limit the amount of current that flows through the first routed line 212 and the power line 216, thereby ensuring that the current flowing through both lines is as equal as possible. In addition, there is a circuitry (not shown in the picture) that detects the status of the current equalization and stops charging immediately to protect the charger 210 and the electronic device 220 in case of accidental unbalance current occurrence in enhanced charging mode.

Thus, the charger 210 of the present invention, through the strategic placement of the resistor 212a and the resistor 216a on the first routed line 212 and the power line 216 respectively, achieves current equalization, thereby ensuring a safe, efficient, and robust charging process for the electronic device 220. Please be noted, placing resistors (using the droop method) is not the only way to achieve current sharing between the two paths of the second power line 216 and the first power line 213. An alternative approach for this application is to use a current mirror circuitry.

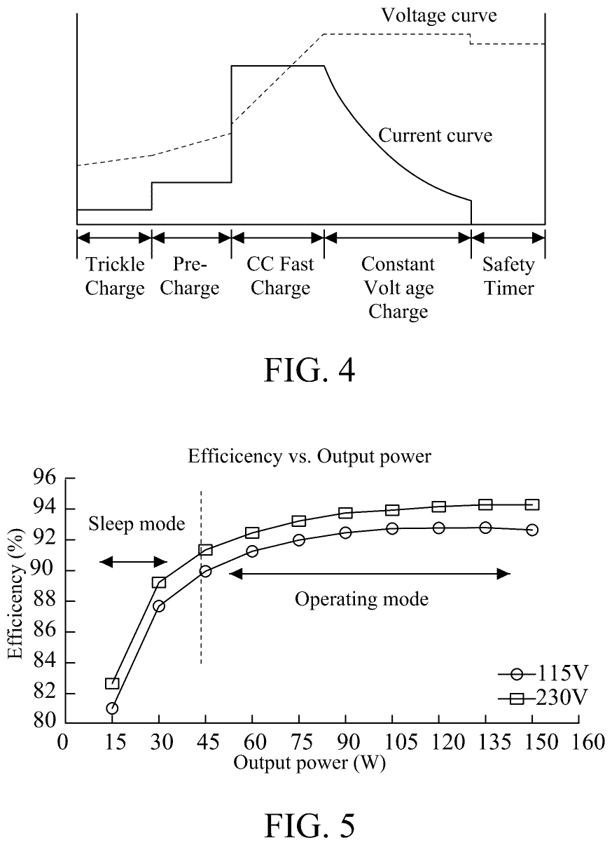

In some embodiment, the charging system 100, 200 employs a multi-stage charging mode as part of its enhanced charging mode. This multi-stage charging mode is designed to optimize the charging process, ensuring that the electronic device 120, 220 is charged efficiently and safely. Please refer to FIG. 4 which illustrates the stages of the multi-stage charging mode. The figure shows how the charging system 200 transitions between the stages based on the charging status of the electronic device 220, ensuring an efficient and safe charging process.

The multi-stage charging mode comprises four primary stages: Trickle Charge, Precharge, CC (constant current) Fast Charge, and Constant Voltage Charge. Each stage is characterized by specific current and voltage parameters, and the charging system 100, 200 transitions between these stages based on the charging status of the electronic device 220.

In the Trickle Charge stage, the charger 210 delivers the lowest constant current to the electronic device 220. This stage is typically used when the battery of the electronic device 220 is deeply discharged. The low current ensures that the battery is gently brought up to a safer charge level. Once the battery reaches a certain charge level, the charging system 200 transitions to the Precharge stage. In this stage, the charger 210 delivers a higher constant current to the electronic device 220. This helps to further increase the charge level of the battery.

The CC Fast Charge stage follows the Precharge stage. In this stage, the charger 210 delivers an even higher constant current to the electronic device 220. This stage is designed to rapidly charge the battery to a significant percentage of its capacity. Once the electronic device 220 has reached a certain level of charge, the charging system 200 transitions from the CC Fast Charge stage to the Constant Voltage Charge stage. In the Constant Voltage Charge stage, the voltage delivered by the charger 210 is kept constant, but the current continues to decrease. This stage ensures that the battery is fully charged without overcharging it, which could potentially lead to damage.

In addition to these four stages, in some embodiment the multi-stage charging mode also includes a Safety Timer stage, as shown in FIG. 4. This stage is designed to prevent overcharge, which could potentially harm the electronic device 220 or reduce the efficiency of the charging process. The Safety Timer stage is activated when the charging current falls below a certain value. If this occurs, the charging process is terminated to prevent any potential issues and undergoes a specific duration before activating Constant Voltage Charge stage.

Overall, the charging system 100, 200 of the present invention, through the implementation of a multi-stage charging mode, ensures that the electronic device 120, 220 is charged efficiently and safely. This approach optimizes the charging process, prolonging the lifespan of the battery and enhancing the overall user experience.

In some embodiment, the charging system 100, 200 of the present invention incorporates a sleep mode to minimize power consumption when the charger 210 is disconnected from the electronic device 110, 220 or falls out of its operating mode. This feature is designed to conserve energy and enhance the overall efficiency of the charging system 100, 200.

When the charger 210 is disconnected from the electronic device 220, or when the charger 210 falls out of its operating mode, the output voltage of power converter 115 is reduced to the lowest permissible working value. This reduction in output voltage triggers the power delivery controller 211 to enter a sleep mode. In this mode, the power delivery controller 211 minimizes its activities, thereby reducing the power consumption of the charger 210. The lowest permissible working value for the output voltage is such as 3.3V in the embodiment. This value is selected to ensure that the power delivery controller 211 can still maintain its basic functions while in sleep mode, but without consuming excessive power.

The operating mode of the charger 210 is defined by an efficiency level. Specifically, the charger 210 is considered to be in its operating mode when it maintains an efficiency level above 90%˜91% with a certain hysteresis. This high efficiency level ensures that the charger 210 is effectively converting power to the electronic device 220 while minimizing energy waste.

Thus, the charging system 100, 200 of the present invention, through the implementation of a sleep mode and a high-efficiency operating mode, ensures optimal power usage. This approach not only conserves energy but also enhances the overall performance and lifespan of the charger 210.

The efficiency of the charger 210 in relation to the output power is further illustrated in FIG. 5. This figure presents a graph with the output power on the x-axis and the efficiency on the y-axis. Two curves are shown in the graph, representing the efficiency-output power relationship when the charger 210 is plugged into a 115V outlet and a 230V outlet, respectively. The graph clearly demonstrates that as the output power increases, the efficiency of the charger 210 also increases. Notably, once the output power exceeds 45 W, the efficiency surpasses the 90% threshold, indicating that the charger 210 has entered its operating mode. This high-efficiency operating mode ensures that the charger 210 is effectively delivering power to the electronic device 220 while minimizing energy waste.

When the output power is less than 45 W, the efficiency drops below 90% quickly, and the charger 210 falls out of its operating mode. At this point, the output voltage of power converter 115 is reduced to the lowest permissible working value of 3.3V, and the power delivery controller 211 enters the sleep mode to minimize power consumption. Different output voltage levels can have different triggered points for entering sleep mode based on efficiency. For example, when the output voltage is 5V, the triggered point for efficiency can be set at 80%.

In conclusion, FIG. 5 provides a visual representation of how the efficiency of the charger 210 varies with the output power and how this relationship influences the operating mode and sleep mode of the charger 210. This graph further underscores the energy-saving benefits of the charging system 200 of the present invention.

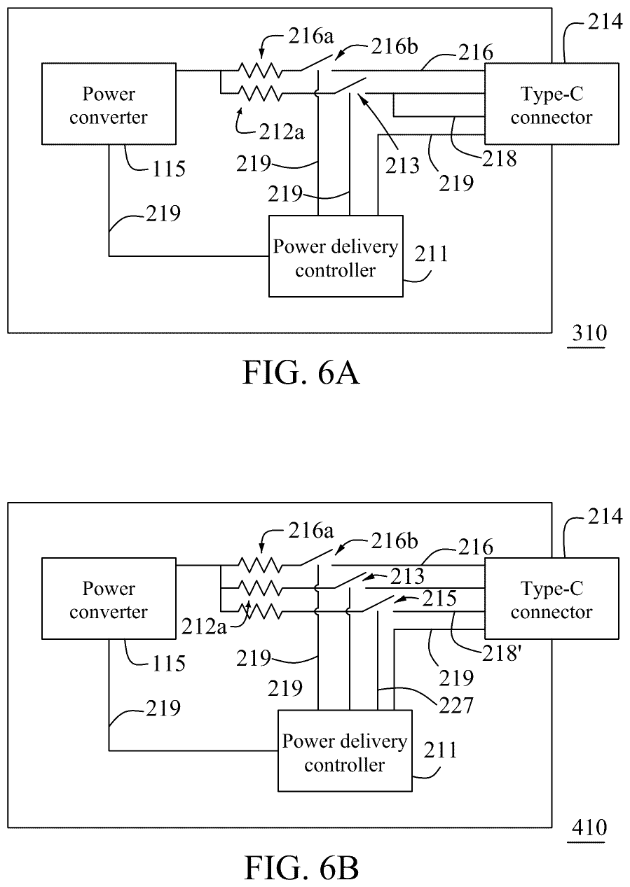

Please refer to FIG. 6A which show a charger of a third embodiment. In this embodiment, the charger 310 is further enhanced with the addition of a third routed line 218. This third routed line 218 is connected to Dp1, Dp2, Dn1, and Dn2 pins of the USB Type-C connector 211. Notably, the Dn1 and Dn2 pins are utilized for grounding purposes.

The third routed line 218 can be pulled from the first routed line 212, allowing it to share the same switch, i.e. the first switch 213. This configuration enables the third routed line 218 and the first routed line 212 to be simultaneously controlled, providing a streamlined and efficient mechanism for managing the power supply to the electronic device 220. By incorporating the third routed line 218, the charger 310 can deliver a higher power output to the electronic device 220 (as shown in FIG. 3).

Please refer to FIG. 6B which show a charger of a fourth embodiment. In the charger 410, the third routed line 218′ is pulled directly from the power line 216. This configuration allows the third routed line 218′ to operate independently of the first routed line 212, providing additional flexibility in the charger's operation. The third routed line 218′ is connected to the Dp1, Dp2, Dn1, and Dn2 pins of the USB Type-C connector 211b. In this configuration, the Dn1 and Dn2 pins are used for grounding, while the Dp1 and Dp2 pins are used for power delivery. This effectively increases the number of pins used for power delivery, potentially enhancing the charging capacity of the charger 210.

To control the flow of power through the third routed line 218′, a fourth switch 215 is installed on the third routed line 218′. The fourth switch 215 operates independently of the first switch 213, allowing the charger 210 to control the power delivery through the third routed line 218′ separately from the first routed line 212. This configuration is particularly useful for charging electronic devices that do not require the Dp and Dn pins for data transfer, such as a battery pack. In this case, the charger 210 can activate all switches, allowing power to flow through the power line 216, the first routed line 212, and the third routed line 218′ and maximizing the charging current.

On the other hand, for electronic devices that still require the Dp/Dn pins for data transfer, the charger 210 can deactivate the fourth switch 215, disconnecting the third routed line 218′ and preserving the data transfer function of the Dp/Dn pins.

Thus, this embodiment of the charger 410 provides a flexible and adaptable charging solution that can cater to the specific needs of different system devices, either maximizing the charging current or preserving the data transfer function of certain pins.

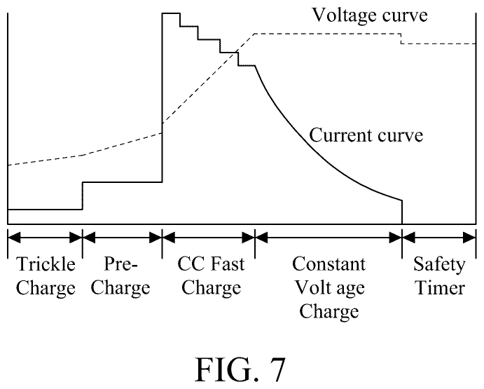

It should be noted that the multi-stage charging mode depicted in FIG. 4 is not confined to the charger described in the previous embodiments. Any charger equipped with a USB Type-C connector can implement the multi-stage charging mode. In other words, the multi-stage charging mode is applicable to a broad array of chargers that utilize a USB Type-C connector. Moreover, as illustrated in FIG. 7, the CC Fast Charge stage can further comprise multiple tiered stages. Each tiered stage transitions from a higher constant current to a lower constant current in a stepwise manner. For instance, during the CC Fast Charge stage, the tiered stages can progressively decrease following a sequence such as 60V, 56V, 52V, 48V, and 42V. This stepwise reduction in current during the CC Fast Charge stage can reduce the overall charging time.

In the practical implementation of the embodiments described above, existing products from various manufacturers can be utilized, thereby eliminating the need for designing new ICs from scratch. For instance, the power delivery controller in the charger can be a product from Weltrend, such as the WT6676 or WT6677, or from Infineon, such as the EZ-PD™ PMG1-S3. Similarly, the power delivery controller in the electronic device can be a product from Infineon, such as EZ-PD™ CCG8, Etron EJ899. These products can be updated via firmware to achieve the control of switches, setting different charging modes and the setting of new functions for pins, such as assigning certain pins for power transmission. Furthermore, the power converter can be a product from Texas Instruments (TI), such as the LM5145 or LM5146. It should be emphasized that these are merely examples, and the implementation of the present invention is not limited to these specific products. Other products with similar functionalities can also be used as per the requirements of the specific application.

The electronic device, as referred to in these embodiments, can encompass a wide range of devices including, but not limited to, laptops, smartphones, e-bikes, e-scooter, home appliances and power tools, etc. Each of these electronic devices has unique power requirements, and the charger of the present invention is designed to cater to these varying needs. Particularly for electronic devices that require a substantial amount of power, such as e-bikes and power tools, the charger can provide a significant advantage. By utilizing the enhanced charging mode and designating additional pins for power delivery, the charger can deliver a higher charging current than typical chargers using a USB Type-C connector. This allows for faster and more efficient charging of high-power devices, improving user experience and device performance.

Moreover, the flexibility of the charger in designating pins for power delivery or data transfer, as well as its ability to operate in different charging modes, makes it a versatile charging solution. It can adapt to the specific needs of the electronic device it is charging, whether the electronic device is a laptop requiring data transfer capabilities, or a e-scooter needing a high charging current.

In summary, the charger of the present invention offers a significant improvement over conventional USB Type-C chargers, providing enhanced charging capabilities and flexibility that can cater to a wide range of electronic devices.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A charger for an electronic device, the charger comprising:
a power delivery controller configured to determine which pins of a USB Type-C connector are used for charging, wherein the power delivery controller is capable of designating pins other than the VBUS pin for charging, and wherein the designated pins are used to distribute current for charging an electronic device, thereby operating in an enhanced charging mode; and
a first routed line connecting a power line of the charger to the designated pins.

2. The charger of claim 1, wherein the designated pins include TX1/TX2 pins used for transmitting bus voltage and RX1/RX2 pins used for grounding.

3. The charger of claim 1, wherein the first routed line includes a switch capable of opening to disconnect the first routed line.

4. The charger of claim 3, wherein the enhanced charging mode is activated when the electronic device supports the enhanced charging mode, and wherein the electronic device includes a second routed line connecting the designated pins to a power line of the electronic device.

5. The charger of claim 4, wherein a handshake between the charger and the electronic device determines whether the electronic device supports the enhanced charging mode, and wherein the switch on the first routed line is closed when the electronic device supports the enhanced charging mode, allowing power to flow through the first and second routed lines and charging to begin, and wherein the switch on the first routed line on the charger is opened, disconnecting the first routed line, and the charger and electronic device revert to standard PD charging when the electronic device does not support the enhanced charging mode.

6. The charger of claim 3, wherein the enhanced charging mode is deactivated when the electronic device does not support the enhanced charging mode.

7. The charger of claim 1, further comprising resistors installed on the first routed line and the power line of the charger to achieve current equalization.

8. The charger of claim 1, wherein the enhanced charging mode comprises a multi-stage charging mode, including a Trickle Charge stage using the lowest constant current, a Precharge stage with a higher constant voltage, a CC Fast Charge stage using an even higher constant current, a Constant Voltage Charge stage where the voltage is kept constant, but the current starts to decrease gradually corresponding to load status.

9. The charger of claim 8, wherein the multi-stage charging mode switches from the CC Fast Charge stage to the Constant Voltage Charge stage once the electronic device has reached a certain voltage level of charge.

10. The charger of claim 8, wherein a Safety Timer stage of the multi-stage charging mode is designed to prevent overcharging and battery damage.

11. The charger of claim 1, wherein when the charger is disconnected from the electronic device or falls out of its operating mode, the output voltage is reduced to the lowest permissible working value, allowing the power delivery controller to enter a sleep mode, minimizing power consumption.

12. The charger of claim 11, wherein the lowest permissible working value is 3.3V.

13. The charger of claim 11, wherein the operating mode is defined as an efficiency level above 80%˜90%, which depends on output voltage level and maximum output power.

14. A charging system for an electronic device, the charging system comprising:
a charger including:
a power delivery controller configured to determine which pins of a USB Type-C connector are used for charging, wherein the power delivery controller is capable of designating pins other than the VBUS pin for charging, and wherein the designated pins are used to distribute current for charging an electronic device, thereby operating in an enhanced charging mode; and
a first routed line connecting a power line of the charger to the designated pins;
an electronic device including a second routed line connecting the designated pins to a power line of the electronic device.

15. The charging system of claim 14, wherein the designated pins include TX1/TX2 pin used for transmitting bus voltage and RX1/RX2 pin used for grounding.

16. The charging system of claim 14, wherein the first routed line includes a first switch capable of opening to disconnect the first routed line and the second routed line includes a second switch capable of opening to disconnect the second routed line.

17. The charging system of claim 16, wherein a handshake between the charger and the electronic device determines whether the electronic device supports the enhanced charging mode, and wherein the first switch on the first routed line is closed when the electronic device supports the enhanced charging mode, allowing power to flow through the first and second routed lines and charging to begin.

18. The charging system of claim 14, further comprising a first resistor installed on the first routed line and a second resistor installed on the second routed line to achieve current equalization.

19. The charging system of claim 14, wherein the enhanced charging mode comprises a multi-stage charging mode, including a Trickle Charge stage using the lowest constant current, a Precharge stage with a higher constant voltage, a CC Fast Charge stage using an even higher constant current, a Constant Voltage Charge stage where the voltage is kept constant, but the current starts to decrease gradually corresponding to load status.

20. The charging system of claim 14, wherein when the charger is disconnected from the electronic device or falls out of its operating mode, the output voltage of power converter is reduced to the lowest permissible working value, allowing the power delivery controller to enter a sleep mode, minimizing power consumption.

21. A charger comprising:
a USB Type-C connector;
a power delivery controller electrically connected to the USB Type-C connector, the power delivery controller configured to control the charging output of the USB Type-C connector and to implement a multi-stage charging mode, wherein the multi-stage charging mode comprises:
a Trickle Charge stage using the lowest constant current;
a Precharge stage with a higher constant voltage;
a CC Fast Charge stage using an even higher constant current; and
a Constant Voltage Charge stage where the voltage is kept constant, but the current starts to decrease gradually corresponding to load status.

22. The charger of claim 21, wherein the CC Fast Charge stage comprises multiple tiered stages, each tiered stage transitioning from a higher constant current to a lower constant current in a stepwise manner.
